(19) United States
(12) Patent Application Publication
(10) Pub. No.: US 2005/0227097 A1
(43) Pub. Date: Oct. 13, 2005

(54) Coating for automotive part

(75) Inventor: Yoshihiko Kawai, Echi-Gun (JP)

Correspondence Address: FOLEY AND LARDNER;SUITE 500, 3000 K STREET NW, WASHINGTON, DC, 20007, US

(73) Assignee: TAKATA CORPORATION

(21) Appl. No.: 11/100,480

(22) Filed: Apr. 7, 2005

Related U.S. Application Data
(60) Provisional application No. 60/561,532, filed on Apr. 13, 2004.

(51) Int. Cl. B32B 15/08

(52) U.S. Cl. 428/457; 428/626

(57) ABSTRACT

A plated automotive part includes a base metal, a chemical conversion coating layer on the base metal; a primer layer on the chemical conversion coating layer; and an outermost plating layer including a resin and a metal foil powder.

### CROSS-REFERENCE TO RELATED APPLICATIONS

This application claims priority to and the benefit of U.S. Provisional Patent Application Ser. No. 60/561,531, filed Apr. 13, 2004, incorporated by reference herein.

### BACKGROUND

The present invention relates to coated automotive parts.

As shown in FIG. 1, some automotive parts 10 are conventionally formed of a base metal 12 (e.g., steel) to which one or more layers of nickel (i.e., “Ni”) 14 is/are applied. An outer layer 16 of sexivalent chrome has conventionally been applied to the outmost layer 14 of Ni to complete the plating of the base metal 12. The layers 14 of Ni may include one or more layers of a semi-bright finish layer 15A of Ni plated onto the base metal 12 and one or more layers of a bright finish layer 15B of Ni plated onto the outermost semi-bright layer 15A of Ni. The automotive part 10 may be plated on one or both sides.

The chrome plating gives the automotive part an attractive appearance and protects the part from scratches and rust because chromium metal has a high surface hardness and excellent wear resistance and corrosion resistance.

Although chrome has proven to be an effective plating material, its use raises environmental concerns. What is needed, therefore, is an automotive plating and method of plating which, like chrome, provides effective plating properties but which is more environmentally friendly than chrome.

### SUMMARY

According to an embodiment of the invention, a plated automotive part includes a base metal, a chemical conversion coating layer on the base metal; a primer layer on the chemical conversion coating layer; and an outermost plating layer including a resin and a metal foil powder.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a cross-sectional view of an automotive part covered with a conventional coating material.

FIG. 2 is a cross-sectional view of an automotive part covered with a coating material according to an embodiment of the present invention.

FIG. 3 is a perspective view of an exemplary automotive part.

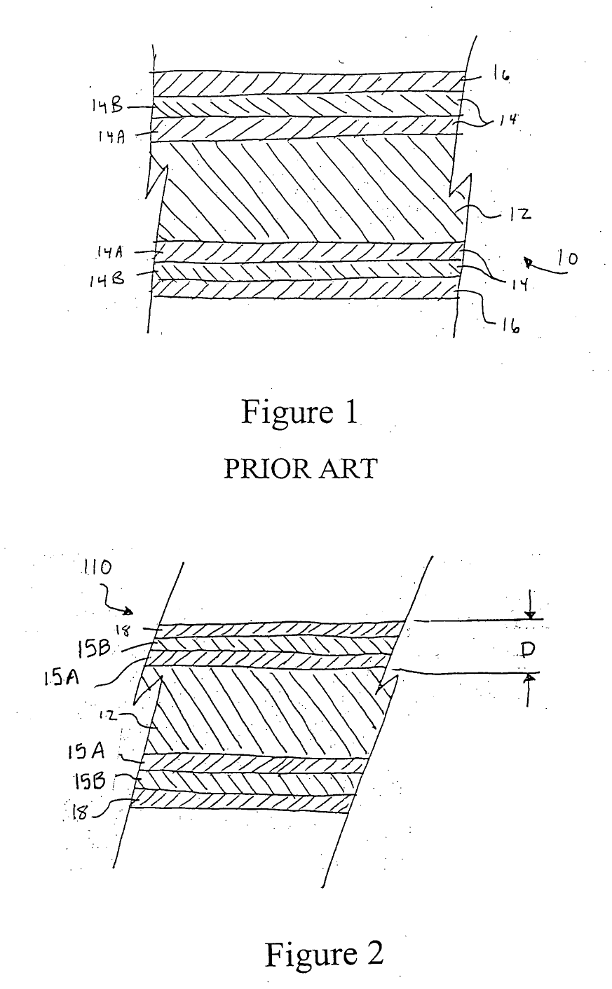

### DETAILED DESCRIPTION

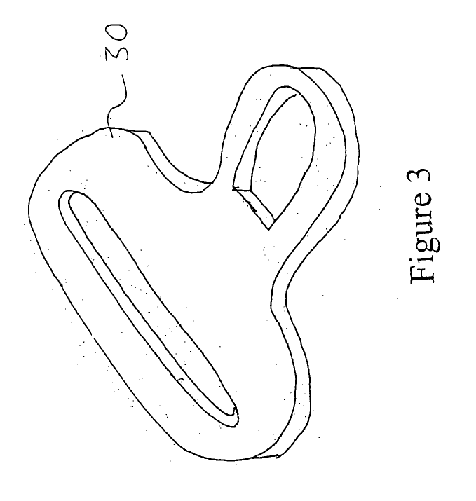

Embodiments of the present invention will be described below with reference to FIGS. 2 and 3.

As shown in FIG. 2, an automotive part 110 includes a base metal 12 (e.g., steel) onto which a layer 15A of a chemical conversion coating is applied. The chemical conversion coating is preferably zinc phosphate. Although only one under layer 15A of the chemical conversion coating is shown, the invention contemplates plated parts involving any number of layers 15A of the chemical conversion coating.

Regardless of the number of layers 15A of the chemical conversion coating, the outermost layer 15A is coated with a layer 15B of primer. Although only one under layer 15B of primer is shown, the invention contemplates plated parts involving any number of layers 15B of primer.

Regardless of the number of layers 15B of primer, the outermost layer 15B is coated with a final layer 18, which is a coating material that comprises a mixture of resin and metal foil powder. The coating material is environmentally friendly and provides improved corrosion and abrasion resistance.

The thickness D of the combined layers 15A, 15B, and 18 is preferably less than or equal to about 100 μm. In addition, although only one outer layer 18 is contemplated in a normal application of the invention, more than one layer 18 may be appropriate for some applications and are, therefore, fully within the scope of the invention.

The resin may be, for example, epoxy, polyamide, acrylic, polyester, or urethane. The metal foil powder may be, for example, SUS (i.e., stainless steel) or aluminum.

According to an embodiment of the present invention, the layer 18 of coating material preferably comprises the coating composition disclosed in JP2000-154338 (incorporated herein by reference).

The layer 18 of coating material may be an anticorrosive coating composition excellent in weather, chemical, and corrosion resistance and in lubricity.

According to an embodiment, the coating material includes an epoxy-based resin containing a curing agent, metal flakes, and a lubricant in a specific proportion. The resin composition is obtained by including (A) 10-80 wt. %, preferably 45-65 wt. %, of an epoxy-based resin (containing a curing agent), (B) 3-50 wt. %, preferably 5-30 wt. %, of metal flakes, and (C) 1-40 wt. %, preferably 5-30 wt. %, of a lubricant. A bisphenol A type, a bisphenol F type, a novolak type, an aliphatic epoxy resin, etc., are preferably used as the epoxy-based resin, and (poly)amines, polyamides, acid anhydrides, urea, etc., are preferably used as the curing agent. Stainless steel flake, etc., are preferably used as the component B. A fluorine-based resin, molybdenum disulfide, tungsten disulfide, carbon, graphite, boron nitride, etc., are preferably used as the component C.

According to an embodiment of the present invention, the metal foil powder is aluminum foil powder such as, for example, the powder disclosed in Japanese Patent Application No. JP2004-501233, incorporated by reference herein.

According to an exemplary embodiment of the present invention, the metal foil powder is stainless steel foil powder such as, for example, the powder disclosed in JP61-228073, incorporated by reference herein. Although JP61-002.1204166.1228073 is directed to a paint, the stainless steel foil powder disclosed therein may be employed in the coating of the present invention to provide a novel coating for automotive parts.

For example, the coating material may include a stainless steel (SUS) foil powder (20 to 80 wt. %). The foil powder may comprise an ultrathin flake having 0.1-0.5 μm thickness, 10-30 μm length, and 5-20 μm width, and effectively a high aspect ratio.

FIG. 5 shows an automotive part 30 plated as described above and shown in FIG. 2. The automotive part 30 may be, for example, a seatbelt tongue (as shown). However, the present invention is not limited to such tongues.

Rather, the invention applies to any automotive part including, but not limited to, a seat belt buckle, a D-ring, and a ball (which is part of a vehicle sensor mounted in a seat belt retractor). Other parts that may be coated according to embodiments of the present invention includes parts used in airbag devices, seat weight sensors, and belt tension sensors. Further by way of example, a child seat, a steering wheel, and vehicle interior parts may be coated.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

1. A plated automotive part comprising:
a base metal;
a chemical conversion coating layer on the base metal;
a primer layer on the chemical conversion coating layer; and
an outermost plating layer including a resin and a metal foil powder.

2. The plated automotive part of claim 1, wherein a combined thickness of the layers is less than about 100 μm.

3. The part of claim 1, wherein the chemical conversion coating comprises zinc phosphate.

4. The part of claim 1, wherein the metal foil powder comprises an aluminum foil powder.

5. The part of claim 1, wherein the metal foil powder comprises a stainless steel foil powder.

6. The part of claim 1, wherein the metal foil powder comprises an-SUS foil powder.

7. The part of claim 1, wherein the outermost plating layer includes 20 to 80 wt. % of SUS foil powder.

8. The part of claim 7, wherein the SUS foil powder comprises flakes having a thickness of about 0.1 to 0.5 μm, a length of about 10-30 μm, and a width of about 5-20 μm.

9. The part of claim 1, wherein the resin comprises epoxy.

10. The part of claim 1, wherein the resin comprises polyamide.

11. The part of claim 1, wherein the resin comprises acrylic.

12. The part of claim 1, wherein the resin comprises polyester.

13. The part of claim 1, wherein the resin comprises urethane.

14. The part of claim 1, wherein the outermost plating layer includes an epoxy-based resin, a curing agent, metal flakes, and a lubricant.

15. The part of claim 14, wherein the outermost plating layer comprises 10 to 80 wt. % of the epoxy-based resin, 3 to 50 wt. % of the metal flakes, and 1 to 40 wt. % of the lubricant, and wherein the epoxy-based resin includes the curing agent.

16. The part of claim 15, wherein the outermost layer comprises 45 to 65 wt. % of an epoxy-based resin containing the curing agent, 5 to 30 wt. % of the metal flakes, and 5 to 30 wt. % of the lubricant.

17. The part of claim 14, wherein the epoxy-based resin comprises an aliphatic epoxy resin.

18. The part of claim 14, wherein the epoxy-based resin comprises a novolak type epoxy resin.

19. The part of claim 14, wherein the epoxy-based resin comprises a bisphenol F type epoxy resin.

20. The part of claim 14, wherein the epoxy-based resin comprises bisphenol A type epoxy resin.

21. The part of claim 14, wherein the curing agent comprises polyamines.

22. The part of claim 14, wherein the curing agent comprises polyamides.

23. The part of claim 14, wherein the curing agent comprises acid anhydrides.

24. The part of claim 14, wherein the curing agent comprises urea.

25. The part of claim 14, wherein the metal flakes comprise stainless steel.

26. The part of claim 14, wherein the lubricant comprises a fluorine-based resin.

27. The part of claim 14, wherein the lubricant comprises molybdenum disulfide.

28. The part of claim 14, wherein the lubricant comprises tungsten disulfide.

29. The part of claim 14, wherein the lubricant comprises carbon.

30. The part of claim 14, wherein the lubricant comprises graphite.

31. The part of claim 14, wherein the lubricant comprises boron nitride.

32. A seat belt tongue comprising a base metal, a chemical conversion coating layer on the base metal, a primer layer on the chemical conversion coating layer, and an outermost plating layer including a resin and a metal foil powder.

33. The tongue of claim 32, wherein a combined thickness of the layers is less than about 100 μm.

34. The tongue of claim 32, wherein the chemical conversion coating comprises zinc phosphate.

35. The tongue of claim 32, wherein the metal foil powder comprises an aluminum foil powder.

36. The tongue of claim 32, wherein the metal foil powder comprises a stainless steel foil powder.

37. The tongue of claim 32, wherein the metal foil powder comprises an SUS foil powder.

38. The tongue of claim 32, wherein the resin comprises epoxy.

39. The tongue of claim 32, wherein the resin comprises polyamide.

40. The tongue of claim 32, wherein the resin comprises acrylic.

41. The tongue of claim 32, wherein the resin comprises polyester.

42. The tongue of claim 32, wherein the resin comprises urethane.
